(19) United States
(12) Patent Application Publication
(10) Pub. No.: US 2024/0256928 A1
(43) Pub. Date: Aug. 1, 2024

(54) METHOD AND DEVICE FOR MUTUALLY INFERRING COMPOSITE CHARACTERISTICS AND COMPOSITE PRODUCTION CONDITIONS THROUGH AUTOENCODER FEATURE EXTRACTION

(71) Applicant: SK Planet Co., Ltd., Seongnam-si (KR)

(72) Inventor: Myungjin KIM, Seoul (KR)

(21) Appl. No.: 18/629,992

(22) Filed: Apr. 9, 2024

Related U.S. Application Data
(63) Continuation of application No. PCT/KR2022/015331, filed on Oct. 12, 2022.

(30) Foreign Application Priority Data
Oct. 13, 2021 (KR) 10-2021-0135686

(51) Int. Cl. G06N 5/046

(52) U.S. Cl. CPC G06N 5/046

(57) ABSTRACT

A method for mutually inferring a complex characteristic and a complex production condition through characteristic extraction of an autoencoder according to the present invention comprises the steps in which: during complex production in which a complex is produced using multiple materials, when there is an encoder trained to calculate a latent vector from a characteristic vector indicating a target complex characteristic, and a production condition vector indicating a production condition for expressing the complex characteristic is input to the encoder, an inference unit calculates, via a first regressor, a copied latent vector copying the latent vector from the input production condition vector; and the inference unit calculates, via a decoder, a copied characteristic vector copying the characteristic vector from the copied latent vector and an experimental condition vector indicating an experimental condition for measuring the complex characteristic.

### CROSS-REFERENCE TO RELATED APPLICATIONS

This application is a bypass continuation of International PCT Application No. PCT/KR2022/015331 filed on Oct. 12, 2022, which claims priority to Republic of Korea Patent Application No. 10-2021-0135686 filed on Oct. 13, 2021, which are incorporated by reference herein in their entirety.

### TECHNICAL FIELD

The present invention relates to technology for inferring composite production recipes, and more particularly, to a method and device for mutually inferring composite characteristics and composite production conditions through autoencoder feature extraction.

### BACKGROUND ART

In the materials engineering industry, a series of processes are repeated to combine various materials to create a new composite and test it in order to create a composite with new characteristics that are better than before. This series of processes requires a very large amount of cost and time. Composites, which are the result of combining multiple materials, can be thought of as having predictable characteristics, but they cannot be predicted because there is no linear relationship between the characteristics and the production recipe.

### SUMMARY

The present invention is intended to provide a method and device for extracting features from the latent space of an autoencoder and, through mutual inference between composite characteristics and production conditions, inferring the production conditions from the characteristics of the composite, and inferring the characteristics of the composite from the production conditions.

In order to achieve the above object, according to an embodiment of the present invention, a method for mutually inferring a composite characteristic and a composite production condition includes, in case that, upon producing a composite using multiple materials, there is an encoder trained to calculate a latent vector from a characteristic vector indicating a target composite characteristic, when a production condition vector indicating a production condition for obtaining the composite characteristic is input, by an inference unit, calculating, through a first regressor, a simulated latent vector simulating the latent vector from the input production condition vector; and by the inference unit, calculating, through a decoder, a simulated characteristic vector simulating the characteristic vector from the simulated latent vector and an experimental condition vector indicating an experimental condition for measuring the composite characteristic.

The method may further include, when a characteristic vector is input, by the inference unit, calculating a latent vector from the characteristic vector through the encoder; and by the inference unit, calculating, through a second regressor, a simulated production condition vector simulating the production condition vector from the latent vector.

The method may further include, before calculating the simulated latent vector, when a learning unit inputs a characteristic vector for learning into the encoder, by the encoder, calculating a latent vector for learning from the characteristic vector for learning; when the learning unit inputs a latent vector for learning and an experimental condition vector for learning into the decoder, by the decoder, calculating a simulated characteristic vector for learning from the latent vector for learning and the experimental condition vector for learning; by the learning unit, calculating a loss representing a difference between the simulated characteristic vector for learning and the characteristic vector for learning; and by the learning unit, performing optimization to update parameters of the encoder and the decoder to minimize the loss.

The method may further include, before calculating the simulated latent vector, by a learning unit, preparing a plurality of learning data, each of which includes a latent vector for learning derived from a characteristic vector for learning by the encoder and a production condition vector for learning corresponding to the characteristic vector for learning; by the learning unit, preparing a prototype of a second regressor in which the latent vector for learning is used as an input, the production condition vector for learning is used as an output, and a weight for the latent vector for learning is not determined; and completing the second regressor by deriving a weight for the latent vector for learning using the learning data.

The method may further include, before calculating the simulated latent vector, by a learning unit, preparing a plurality of learning data, each of which includes a production condition vector for learning and a latent vector for learning derived from a characteristic vector for learning corresponding to the production condition vector for learning by the encoder; by the learning unit, preparing a prototype of a first regressor in which the production condition vector for learning is used an input, the latent vector for learning is used as an output, and a weight of the production condition vector for learning is not determined; and completing the first regressor by deriving a weight of the production condition vector for learning using the learning data.

In order to achieve the above object, according to an embodiment of the present invention, a device for mutually inferring a composite characteristic and a composite production condition includes, in case that, upon producing a composite using multiple materials, there is an encoder trained to calculate a latent vector from a characteristic vector indicating a target composite characteristic, an inference unit, when a production condition vector indicating a production condition for obtaining the composite characteristic is input, calculating, through a first regressor, a simulated latent vector simulating the latent vector from the input production condition vector, and calculating, through a decoder, a simulated characteristic vector simulating the characteristic vector from the simulated latent vector and an experimental condition vector indicating an experimental condition for measuring the composite characteristic.

The inference unit, when a characteristic vector is input, may calculate a latent vector from the characteristic vector through the encoder, and calculate, through a second regressor, a simulated production condition vector simulating the production condition vector from the latent vector.

The device may further include a learning unit inputting a characteristic vector for learning into the encoder such that the encoder calculates a latent vector for learning from the characteristic vector for learning, inputting a latent vector for learning and an experimental condition vector for learning into the decoder such that the decoder calculates a simulated characteristic vector for learning from the latent vector for learning and the experimental condition vector for learning, calculating a loss representing a difference between the simulated characteristic vector for learning and the characteristic vector for learning, and performing optimization to update parameters of the encoder and the decoder to minimize the loss.

The device may further include a learning unit preparing a plurality of learning data, each of which includes a latent vector for learning derived from a characteristic vector for learning by the encoder and a production condition vector for learning corresponding to the characteristic vector for learning, preparing a prototype of a second regressor in which the latent vector for learning is used as an input, the production condition vector for learning is used as an output, and a weight for the latent vector for learning is not determined, and completing the second regressor by deriving a weight for the latent vector for learning using the learning data.

The device may further include a learning unit preparing a plurality of learning data, each of which includes a production condition vector for learning and a latent vector for learning derived from a characteristic vector for learning corresponding to the production condition vector for learning by the encoder, preparing a prototype of a first regressor in which the production condition vector for learning is used an input, the latent vector for learning is used as an output, and a weight of the production condition vector for learning is not determined, and completing the first regressor by deriving a weight of the production condition vector for learning using the learning data.

According to the present invention, if a sufficiently large amount of data on production conditions and corresponding composite characteristics are available, it is possible to perform various simulations on various combinations of production conditions and composite characteristics. Also, it is possible to make predictions from experiments under various conditions for one production condition. Accordingly, the number of tests can be reduced when creating a new composite, and a combination can be traced back to the desired result.

### BRIEF DESCRIPTION OF DRAWINGS

FIG. 1 is a diagram illustrating the configuration of a device for mutually inferring composite characteristics and composite production conditions through autoencoder feature extraction according to an embodiment of the present invention.

FIG. 2 is a diagram illustrating the configuration of an inference model for mutually inferring composite characteristics and composite production conditions through autoencoder feature extraction according to an embodiment of the present invention.

FIG. 3 is a flowchart illustrating a learning method for an inference model (IM) for mutually inferring composite characteristics and composite production recipes according to an embodiment of the present invention.

FIG. 4 is a flowchart illustrating a method for optimizing an autoencoder for mutually inferring composite characteristics and composite production recipes according to an embodiment of the present invention.

FIG. 5 is a flowchart illustrating a method for optimizing a second regressor for mutually inferring composite characteristics and composite production recipes according to an embodiment of the present invention.

FIG. 6 is a flowchart illustrating a method for optimizing a first regressor for mutually inferring composite characteristics and composite production recipes according to an embodiment of the present invention.

FIG. 7 is a flowchart illustrating a method for mutually inferring composite characteristics and composite production conditions through autoencoder feature extraction according to an embodiment of the present invention.

FIG. 8 is an exemplary diagram of a hardware system for implementing a device for mutually inferring composite characteristics and composite production conditions through autoencoder feature extraction according to an embodiment of the present invention.

### DETAILED DESCRIPTION

In order to clarify the characteristics and advantages of the technical solution of the present invention, the present invention will be described in detail through specific embodiments of the present invention with reference to the accompanying drawings.

However, in the following description and the accompanying drawings, well known techniques may not be described or illustrated to avoid obscuring the subject matter of the present invention. Through the drawings, the same or similar reference numerals denote corresponding features consistently.

The terms and words used in the following description, drawings and claims are not limited to the bibliographical meanings thereof and are merely used by the inventor to enable a clear and consistent understanding of the invention. Thus, it will be apparent to those skilled in the art that the following description about various embodiments of the present invention is provided for illustration purpose only and not for the purpose of limiting the invention as defined by the appended claims and their equivalents.

Additionally, the terms including expressions “first”, “second”, etc. are used for merely distinguishing one element from other elements and do not limit the corresponding elements. Also, these ordinal expressions do not intend the sequence and/or importance of the elements.

Further, when it is stated that a certain element is “coupled to” or “connected to” another element, the element may be logically or physically coupled or connected to another element. That is, the element may be directly coupled or connected to another element, or a new element may exist between both elements.

In addition, the terms used herein are only examples for describing a specific embodiment and do not limit various embodiments of the present invention. Also, the terms “comprise”, “include”, “have”, and derivatives thereof refer to inclusion without limitation. That is, these terms are intended to specify the presence of features, numerals, steps, operations, elements, components, or combinations thereof, which are disclosed herein, and should not be construed to preclude the presence or addition of other features, numerals, steps, operations, elements, components, or combinations thereof.

In addition, the terms such as “unit” and “module” used herein refer to a unit that processes at least one function or operation and may be implemented with hardware, software, or a combination of hardware and software.

In addition, the terms “a”, “an”, “one”, “the”, and similar terms are used herein in the context of describing the present invention (especially in the context of the following claims) may be used as both singular and plural meanings unless the context clearly indicates otherwise

Also, embodiments within the scope of the present invention include computer-readable media having computer-executable instructions or data structures stored on computer-readable media. Such computer-readable media can be any available media that is accessible by a general purpose or special purpose computer system. By way of example, such computer-readable media may include, but not limited to, RAM, ROM, EPROM, CD-ROM or other optical disk storage, magnetic disk storage or other magnetic storage devices, or any other physical storage medium that can be used to store or deliver certain program codes formed of computer-executable instructions, computer-readable instructions or data structures and which can be accessed by a general purpose or special purpose computer system.

In addition, the present invention may be implemented in network computing environments having various kinds of computer system configurations such as PCs, laptop computers, handheld devices, multiprocessor systems, microprocessor-based or programmable consumer electronics, network PCs, minicomputers, mainframe computers, mobile phones, PDAs, pagers, and the like. The present invention may also be implemented in distributed system environments where both local and remote computer systems linked by a combination of wired data links, wireless data links, or wired and wireless data links through a network perform tasks. In such distributed system environments, program modules may be located in local and remote memory storage devices.

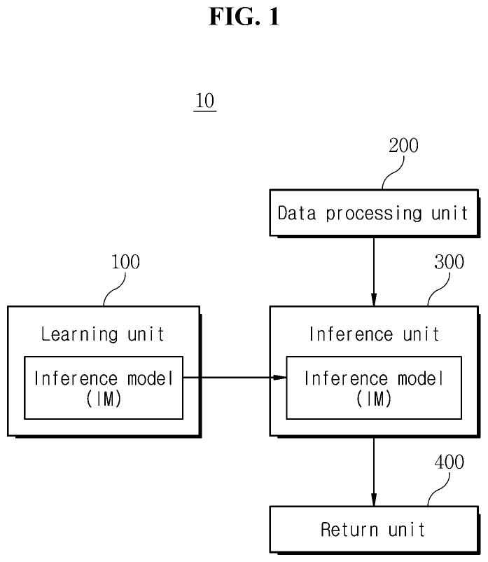

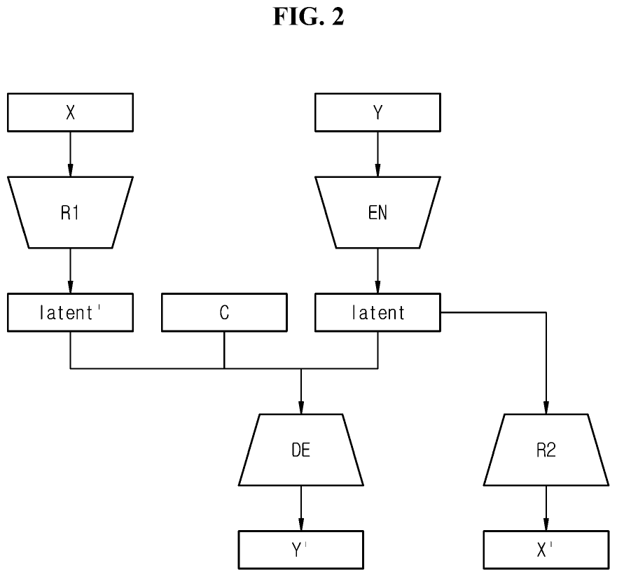

At the outset, the configuration of a device for inferring a composite production recipe based on a generative adversarial network according to an embodiment of the present invention will be described. FIG. 1 is a diagram illustrating the configuration of a device for mutually inferring composite characteristics and composite production conditions through autoencoder feature extraction according to an embodiment of the present invention. FIG. 2 is a diagram illustrating the configuration of an inference model for mutually inferring composite characteristics and composite production conditions through autoencoder feature extraction according to an embodiment of the present invention.

Referring to FIGS. 1 and 2, an inference device 10 according to an embodiment of the present invention includes a learning unit 100, a data processing unit 200, an inference unit 300, and a return unit 400.

The learning unit 100 is for deep learning of an inference model (IM), which is a deep learning model according to an embodiment of the present invention. The learning-finished inference model (IM) is used in the inference unit 300. The inference model (IM) is a learning model for deriving production conditions applied to production for obtaining target composite characteristics upon producing a composite using multiple materials, or a learning model for deriving the characteristics of a composite from experimental conditions for measuring production conditions and composite characteristics. Here, the form of the composite includes various forms such as iron, plastic, rubber, medicine, chemicals, and cooking. The production conditions include types of materials, ratios of materials, methods of mixing materials, methods of processing individual materials or mixed materials, and the like. The composite characteristics may include, for example, in plastics, bending or impact resistance, pressure resistance, elasticity, and the like. The experimental conditions are conditions on the outside of the composite in performing the experiment, such as impact applied in the case of impact resistance or pressure applied in the case of pressure resistance, for example, in plastics, and include various conditions presented to measure the characteristics of the composite.

The data processing unit 200, when data is input, maps the input data into a predetermined vector space. That is, if the input data is a production condition, the data processing unit 200 maps the input production condition into a predetermined vector space to generate a production condition vector (X) indicating the production condition. If the input data is an experimental condition for measuring the characteristics of a production-finished composite, the data processing unit 200 maps the input experimental condition into a predetermined vector space to generate an experimental condition vector (C). If the input data is the characteristic of a composite, the data processing unit 200 maps the input composite characteristic into a predetermined vector space to generate a characteristic vector (Y). Here, the production condition vector (X), the experimental condition vector (C), and the characteristic vector (Y) may be 1-dimensional to N-dimensional vectors or matrices. In particular, the characteristic vector (Y) may have temporal characteristics or spatial characteristics. In this case, the characteristic vector (Y) may be a test time series result or a single characteristic vector.

Using the learning-finished inference model (IM) by the learning unit 100, the inference unit 300 is capable of deriving a simulated characteristic vector (Y′) that simulates the characteristic vector (Y) indicating the composite characteristics from the production condition vector (X) and the experimental condition vector (C), or deriving a simulated production condition vector (X′) that simulates the production condition vector (X) from the characteristic vector (Y).

Meanwhile, referring to FIG. 2, the inference model (IM) includes an autoencoder (AE) having an encoder (EN) and a decoder (DE), a first regressor (Regressor1: R1), and a second regressor (Regressor2: R2).

The encoder (EN) includes a plurality of convolution layers (CLs) involving convolution operations and operations by an activation function. Additionally, a pooling layer (PL) that performs a maximum pooling operation may be applied between the convolutional layers (CLs) of the encoder (EN).

The decoder (DE) includes a plurality of deconvolution layers (DLs) involving deconvolution operations and operations by an activation function.

Although the encoder (EN) and the decoder (DE) are explained as using convolution layers, they are not limited to this. Various artificial neural networks such as fully connected (FC) layers or recurrent neural network (RVV) series may be used.

As described above, the autoencoder (AE) includes multiple layers, and the multiple layers include multiple operations. Additionally, the multiple layers are connected by weight (w). The operation result of one layer is weighted and become an input to the next layer node. In other words, one layer of the autoencoder (AE) receives as an input a value with weight applied from the previous layer, performs an operation on it, and delivers the operation result as an input to the next layer.

The first regressor (R1) receives a production condition vector (X) as an input, has a weight for the production condition vector (X), and outputs a simulated latent vector (latent′).

The second regressor (R2) receives a latent vector (latent) as an input, has a weight for the latent vector (latent), and outputs a simulated production condition vector (X′).

When a characteristic vector (Y) representing the characteristics of a composite is input, the encoder (EN) calculates the latent vector (latent) by performing a plurality of operations in which weights between multiple layers are applied to the characteristic vector (Y). Here, the latent vector (latent) represents the features of the composite characteristics appearing in the latent spaces of the autoencoder (AE).

When the production condition vector (X) is input, the first regressor (R1) calculates the simulated latent vector (latent′) by performing an operation in which a learned weight is applied to the production condition vector (X). Here, the simulated latent vector (latent′) is obtained by simulating the latent vector (latent) calculated by the encoder (EN).

When either the latent vector (latent) calculated by the encoder (EN) or the simulated latent vector (latent′) calculated by the first regressor (R1) and the experimental condition vector (C) are input, the decoder (DE) calculates a simulated characteristic vector (Y′) by performing a plurality of operations in which weights between multiple layers are applied to either the latent vector (latent) or the simulated latent vector (latent′) and the experimental condition vector (C).

When the latent vector (latent) is input, the second regressor (R2) calculates the simulated production condition vector (X′) by performing an operation in which a learned weight is applied to the latent vector (latent).

Referring again to FIG. 1, the return unit 400 is for returning an output corresponding to data input to the inference device 10. That is, when the composite characteristics are input to the data processing unit 200, the return unit 400 returns the production conditions indicated by the simulated production condition vector (X′) derived by the inference unit 300 in response to the input composite characteristics. In addition, when the production conditions and the experimental conditions are input to the data processing unit 200, the return unit 400 returns the composite characteristics indicated by the simulated characteristic vector (Y′) derived by the inference unit 300 in response to the input production conditions.

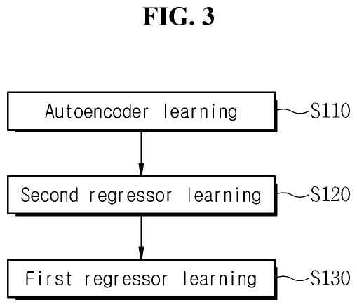

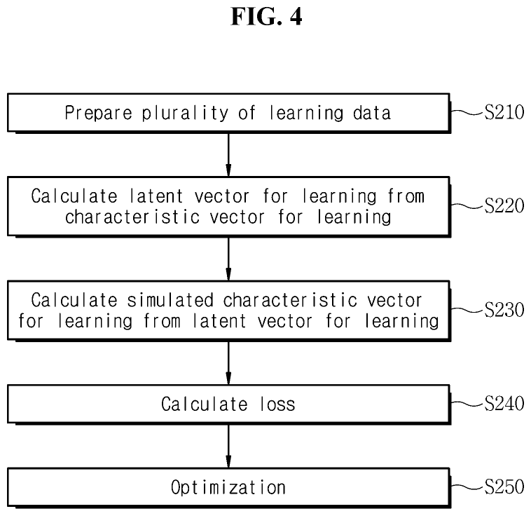

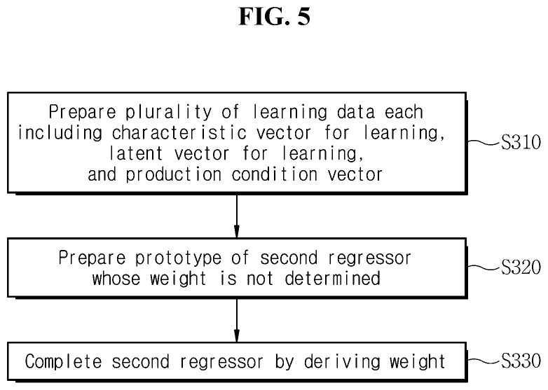

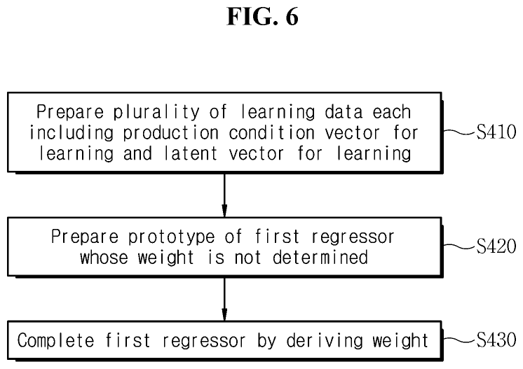

Next, a learning method for the inference model (IM) for mutually inferring the composite characteristics and the composite production recipes through the autoencoder feature extraction according to an embodiment of the present invention will be described. FIG. 3 is a flowchart illustrating a learning method for an inference model (IM) for mutually inferring composite characteristics and composite production recipes according to an embodiment of the present invention. FIG. 4 is a flowchart illustrating a method for optimizing an autoencoder for mutually inferring composite characteristics and composite production recipes according to an embodiment of the present invention. FIG. 5 is a flowchart illustrating a method for optimizing a second regressor for mutually inferring composite characteristics and composite production recipes according to an embodiment of the present invention. FIG. 6 is a flowchart illustrating a method for optimizing a first regressor for mutually inferring composite characteristics and composite production recipes according to an embodiment of the present invention.

At the outset, referring to FIG. 3, in learning of the inference model (IM) according to an embodiment of the present invention, the learning unit 100 trains the autoencoder in step S110, trains the second regressor in step S120, and trains the first regressor in step S130. Now, each of these steps S110 to S130 will be described in detail.

Hereinafter, the autoencoder learning method in step S110 will be described in detail with reference to FIG. 4.

The learning unit 100 prepares a plurality of learning data in step S210. The learning data are a characteristic vector for learning and a corresponding experimental condition vector for learning.

When the learning data are prepared, the learning unit 100 inputs the characteristic vector for learning to the encoder (EN) in step S220, and then the encoder (EN) calculates a latent vector for learning by performing multiple operations in which an unlearned weight is applied to the characteristic vector for learning.

Next, in step S230, the learning unit 100 inputs the latent vector for learning previously calculated by the encoder (EN) and the experimental condition vector for learning prepared as the learning data to the decoder, and then the decoder (DE) calculates a simulated characteristic vector for learning that simulates the characteristic vector for learning from the latent vector for learning and the experimental condition vector for learning.

Then, the learning unit 100 calculates a loss representing a difference between the simulated characteristic vector for learning and the characteristic vector for learning through a loss function in step S240. Here, the loss function may include mean squared error (MSE), mean absolute error (MAE), cross entropy error (CEE), or the like.

Next, in step S250, in order to minimize the loss, the learning unit 100 performs optimization to update parameters of the autoencoder including the encoder (EN) and decoder (DE), that is, a weight (w), through a backpropagation algorithm.

Steps S220 to S250 described above can be performed repeatedly until the simulated characteristic vector for learning is calculated using a plurality of different learning data and then the resulting loss becomes less than a predetermined target value.

Next, the second regressor learning method in step S120 will be described in detail with reference to FIG. 5.

The learning unit 100 prepares a plurality of learning data for training the second regressor in step S310. Here, each of the plurality of learning data includes the latent vector for learning derived from the characteristic vector for learning by the encoder EN and a production condition vector for learning corresponding to the characteristic vector for learning.

Next, in step S320, the learning unit 100 prepares a prototype of the second regressor whose weight is not determined. Here, the prototype of the second regressor is a function in which a latent vector for learning is used as an input, a production condition vector for learning is used as an output, and a weight for the latent vector for learning is not determined.

Then, in step S330, the learning unit 100 completes the second regressor by deriving a weight of the prototype of the second regressor, that is, the weight for the latent vector for learning, through regression analysis using the plurality of learning data.

Next, the first regressor learning method the step S130 will be described in detail with reference to FIG. 6.

The learning unit 100 prepares a plurality of learning data for training the first regressor in step S410. Here, each of the plurality of learning data includes the production condition vector for learning and the latent vector for learning derived from the characteristic vector for learning corresponding to the production condition vector for learning by the encoder (EN).

Next, in step S420, the learning unit 100 prepares a prototype of the first regressor whose weight is not determined. Here, the prototype of the first regressor is a function in which the production condition vector for learning is used as an input, the latent vector for learning is used as an output, and a weight for the production condition vector for learning is not determined. Then, in step S430, the learning unit 100 completes the first regressor by deriving a weight of the prototype of the first regressor, that is, the weight for the production condition vector for learning, through regression analysis using the plurality of learning data.

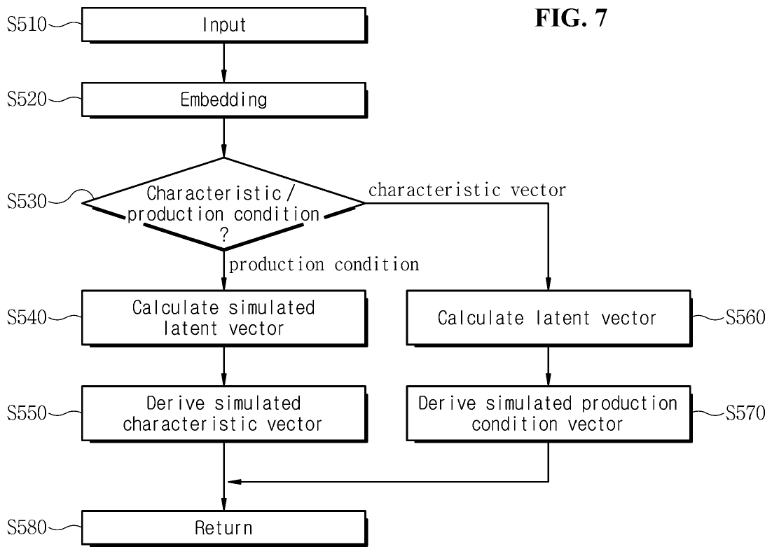

When learning of the inference model (IM) including the autoencoder (AE), the first regressor (R1), and the second regressor (R2) is completed according to the procedure described above, it is possible to use the inference model (IM) to infer production conditions that allow the characteristics of a target composite to be expressed in composite production or to infer the characteristics of a composite when the composite is produced according to the production conditions. Now, a method for mutually inferring composite characteristics and composite production conditions through autoencoder feature extraction according to an embodiment of the present invention will be described. FIG. 7 is a flowchart illustrating a method for mutually inferring composite characteristics and composite production conditions through autoencoder feature extraction according to an embodiment of the present invention.

Referring to FIG. 7, when data is input in step S510, the data processing unit 200 embeds the input data into a predetermined vector space in step S520. That is, if the input data is a production condition applied to the production of a composite using a plurality of materials, the data processing unit 200 generates a production condition vector (X) by mapping the production condition into a predetermined vector space, and provides it to the inference unit 300. Alternatively, if the input data is a composite characteristic targeted in producing the composite, the data processing unit 200 generates a characteristic vector (Y) by mapping the composite characteristic into a predetermined vector space, and provides it to the inference unit 300. Alternatively, if the input data is an experimental condition for measuring the characteristics of a production-finished composite, the data processing unit 200 generates an experimental condition vector (C) by mapping the experimental conditions into a predetermined vector space, and provides it to the inference unit 300.

Meanwhile, according to learning as described in FIGS. 3 to 6, the inference model (IM) can derive the simulated characteristic vector (Y′) that simulates the characteristic vector (Y) from the production condition vector (X) and the experimental condition vector (C), or derive the simulated production condition vector (X′) that simulates the production condition vector (X) from the characteristic vector (Y). Therefore, in step S530, the inference unit 300 determines whether the input data includes the characteristic vector (Y) or the production condition vector (X).

Upon determination in step S530 that the input data from the data processing unit 200 includes the production condition vector (X), the inference unit 300 proceeds to step S540. In step S540, through the first regressor (R1), the inference unit 300 calculates the simulated latent vector (latent′) that simulates the latent vector (latent) from the production condition vector (X) input. Here, the latent vector (latent) is calculated from the characteristic vector (Y) by the encoder (EN). That is, when the production condition vector (X) is input by the inference unit 300, the first regressor (R1) applies the learned weight to the production condition vector (X) and calculates the simulated latent vector (latent′) that simulates the latent vector (latent) calculated from the characteristic vector (Y) used as an input by the encoder (EN). Subsequently, in step S550, through the decoder (DE), the inference unit 300 calculates the simulated characteristic vector (Y′) that simulates the characteristic vector (Y) from the simulated latent vector (latent′) and the experimental condition vector (C) indicating the experimental conditions for measuring the composite characteristics. That is, when the simulated latent vector (latent′) and the experimental condition vector (C) are input from the inference unit 300, the decoder (DE) calculates the simulated characteristic vector (Y′) that simulates the characteristic vector (Y) through a plurality of operations in which learned weights between multiple layers are applied for the simulated latent vector (latent′) and the experimental condition vector (C). Here, the calculated simulated characteristic vector (Y′) represents the characteristics of a composite measured according to experimental conditions indicated by the experimental condition vector (C) when the composite is produced according to production conditions indicated by the production condition vector (X). Then, in step S580, the return unit 400 returns the composite characteristics indicated by the simulated characteristic vector (Y′).

On the other hand, upon determination in step S530 that the input data from the data processing unit 200 includes the characteristic vector (Y), the inference unit 300 proceeds to step S560.

In step S560, through the encoder (EN), the inference unit 300 calculates the latent vector (latent) from the characteristic vector (Y). That is, when the characteristic vector (Y) is input by the inference unit 300, the encoder (EN) calculates the latent vector (latent) through a plurality of operations in which learned weights between multiple layers are applied by the characteristic vector (Y). Subsequently, in step S570, through the second regressor (R2), the inference unit 300 calculates the simulated production condition vector (X′) that simulates the production condition vector (X) from the latent vector (latent). That is, when the latent vector (latent) is input from the inference unit 300, the second regressor (R2) calculates the simulated production condition vector (X′) by applying learned weights to the latent vector (latent). Here, the calculated simulated production condition vector (X′) represents the production conditions for producing a composite having the composite characteristics indicated by the characteristic vector (Y). Then, in step S580, the return unit 400 returns the production conditions indicated by the simulated production condition vector (X′).

Each component in the inference device 10 described above may be implemented in the form of a software module or hardware module executed by a processor, or may be implemented in the form of a combination of a software module and a hardware module.

As above, a software module, a hardware module, or a combination of a software module and a hardware module, executed by a processor, may be implemented as an actual hardware system (e.g., a computer system).

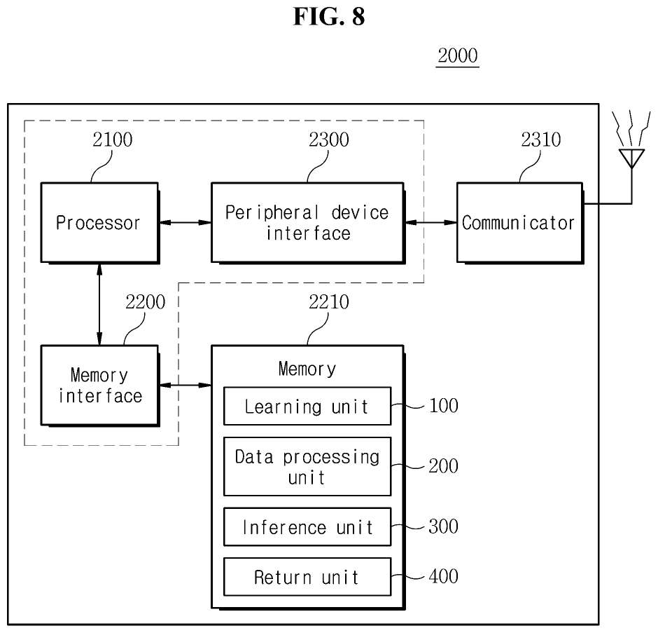

Hereinafter, a hardware system 2000 that implements the inference device 10 according to an embodiment of the present invention in hardware form will be described with reference to FIG. 8.

For reference, the following description is only an example of each component in the above-described inference device 10 implemented as the hardware system 2000, and each component and its operation may be different from the actual system.

As shown in FIG. 8, the hardware system 2000 according to an embodiment of the present invention may include a processor 2100, a memory interface 2200, and a peripheral device interface 2300.

These respective elements in the hardware system 2000 may be individual components or be integrated into one or more integrated circuits and may be combined by a bus system (not shown).

Here, the bus system is an abstraction that represents any one or more separate physical buses, communication lines/interfaces, and/or multi-drop or point-to-point connections, connected by appropriate bridges, adapters, and/or controllers.

The processor 2100 serves to execute various software modules stored in the memory 2210 by communicating with the memory 2210 through the memory interface 2200 in order to perform various functions in the hardware system.

In the memory 2210, the learning unit 100, the data processing unit 200, the inference unit 300, and the return unit 400, which are components of the inference device 10, may be stored in the form of software modules, and the operating system (OS) may be further stored.

The operating system (e.g., embedded operating system such as I-OS, Android, Darwin, RTXC, LINUX, UNIX, OS X, WINDOWS, or VxWorks) includes various procedures, command sets, software components and/or drivers that control and manage general system tasks (e.g., memory management, storage device control, power management, etc.) and plays a role in facilitating communication between various hardware modules and software modules.

The memory 2210 may include a memory hierarchy including, but not limited to, a cache, a main memory, and a secondary memory. The memory hierarchy may be implemented via, for example, any combination of RAM (e.g., SRAM, DRAM, DDRAM), ROM, FLASH, magnetic and/or optical storage devices (e.g., disk drive, magnetic tape, compact disk (CD), digital video disc (DVD)).

The peripheral device interface 2300 serves to enable communication between the processor 2100 and peripheral devices.

The peripheral devices are to provide different functions to the hardware system 2000, and in one embodiment of the present invention, a communicator 2310 may be included, for example.

The communicator 2310 serves to provide a communication function with other devices. For this purpose, the communicator 2310 may include, for example, but not limited to, an antenna system, an RF transceiver, one or more amplifiers, a tuner, one or more oscillators, and a digital signal processor, a CODEC chipset, and a memory, and may also include a known circuit that performs this function.

The communicator 2310 may support communication protocols such as, for example, WLAN (Wireless LAN), DLNA (Digital Living Network Alliance), Wibro (Wireless Broadband), Wimax (World Interoperability for Microwave Access), GSM (Global System for Mobile communication), CDMA (Code Division Multi Access), CDMA2000 (Code Division Multi Access 2000), EV-DO (Enhanced Voice-Data Optimized or Enhanced Voice-Data Only), WCDMA (Wideband CDMA), HSDPA (High Speed Downlink Packet Access), HSUPA (High Speed Uplink Packet Access), IEEE 802.16, LTE (Long Term Evolution), LTE-A (Long Term Evolution-Advanced), 5G communication system, WMBS (Wireless Mobile Broadband Service), Bluetooth, RFID (Radio Frequency Identification), IrDA (Infrared Data Association), UWB (Ultra-Wideband), ZigBee, NFC (Near Field Communication), USC (Ultra Sound Communication), VLC (Visible Light Communication), Wi-Fi, Wi-Fi Direct, and the like. In addition, as wired communication networks, wired LAN (Local Area Network), wired WAN (Wide Area Network), PLC (Power Line Communication), USB communication, Ethernet, serial communication, optical/coaxial cables, etc. may be included. This is not a limitation, and any protocol capable of providing a communication environment with other devices may be included.

In the hardware system 2000 according to an embodiment of the present invention, each element of the inference device 10 stored in the memory 2210 in the form of a software module performs an interface with the communicator 2310 via the memory interface 2200 and the peripheral device interface 2300 in the form of a command executed by the processor 2100.

While the specification contains many specific implementation details, these should not be construed as limitations on the scope of any disclosure or of what may be claimed, but rather as descriptions of features that may be specific to particular embodiments of particular disclosures. Certain features that are described in the specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Also, although the present specifications describe that operations are performed in a predetermined order with reference to a drawing, it should not be construed that the operations are required to be performed sequentially or in the predetermined order, which is illustrated to obtain a preferable result, or that all of the illustrated operations are required to be performed. In some cases, multi-tasking and parallel processing may be advantageous. Also, it should not be construed that the division of various system components are required in all types of implementation. It should be understood that the described program components and systems are generally integrated as a single software product or packaged into a multiple-software product.

Specific embodiments of the subject matter have been described in the disclosure. Other embodiments are within the scope of the following claims. For example, the operations recited in the claims can be performed in a different order and still achieve desirable results. As an example, the process depicted in the accompanying drawings does not necessarily require the depicted order or sequential order to achieve desirable results. In certain implementations, multitasking and parallel processing may be advantageous.

This description shows the best mode of the present invention and provides examples to illustrate the present invention and to enable a person skilled in the art to make and use the present invention. The present invention is not limited by the specific terms used herein. Based on the above-described embodiments, one of ordinary skill in the art can modify, alter, or change the embodiments without departing from the scope of the present invention.

Accordingly, the scope of the present invention should not be limited by the described embodiments and should be defined by the appended claims.

The present invention relates to a method and device for mutually inferring composite characteristics and composite production conditions through autoencoder feature extraction. If a sufficiently large amount of data on production conditions and corresponding composite characteristics are available, it is possible to perform various simulations on various combinations of production conditions and composite characteristics. Also, it is possible to make predictions from experiments under various conditions for one production condition. Accordingly, the number of tests can be reduced when creating a new composite, and a combination can be traced back to the desired result. Thus, the present invention has sufficient possibility of commercialization or sales. In addition, since it can be clearly implemented in reality, there is industrial applicability.

### Reference Numerals

10: Inference device
100: Learning unit
200: Data processing unit
300: Inference unit
400: Return unit

What is claimed is:

1. A method for mutually inferring a composite characteristic and a composite production condition, the method comprising:
in case that, upon producing a composite using multiple materials, there is an encoder trained to calculate a latent vector from a characteristic vector indicating a target composite characteristic,
when a production condition vector indicating a production condition for obtaining the composite characteristic is received, by an inference unit, calculating, through a first regressor, a simulated latent vector simulating the latent vector from the input production condition vector; and
by the inference unit, calculating, through a decoder, a simulated characteristic vector simulating the characteristic vector from the simulated latent vector and an experimental condition vector indicating an experimental condition for measuring the composite characteristic.

2. The method of claim 1, further comprising:
when a characteristic vector is received, by the inference unit, calculating a latent vector from the characteristic vector through the encoder; and
by the inference unit, calculating, through a second regressor, a simulated production condition vector simulating the production condition vector from the latent vector.

3. The method of claim 2, further comprising:
before calculating the simulated latent vector,
when a learning unit receives a characteristic vector for learning into the encoder, by the encoder, calculating a latent vector for learning from the characteristic vector for learning;
when the learning unit receives a latent vector for learning and an experimental condition vector for learning into the decoder, by the decoder, calculating a simulated characteristic vector for learning from the latent vector for learning and the experimental condition vector for learning;
by the learning unit, calculating a loss representing a difference between the simulated characteristic vector for learning and the characteristic vector for learning; and
by the learning unit, performing optimization to update parameters of the encoder and the decoder to minimize the loss.

4. The method of claim 2, further comprising:
before calculating the simulated latent vector,
by a learning unit, preparing a plurality of learning data, each of which includes a latent vector for learning derived from a characteristic vector for learning by the encoder and a production condition vector for learning corresponding to the characteristic vector for learning;
by the learning unit, preparing a prototype of a second regressor in which the latent vector for learning is used as an input, the production condition vector for learning is used as an output, and a weight for the latent vector for learning is not determined; and
completing the second regressor by deriving a weight for the latent vector for learning using the learning data.

5. The method of claim 2, further comprising:
before calculating the simulated latent vector,
by a learning unit, preparing a plurality of learning data, each of which includes a production condition vector for learning and a latent vector for learning derived from a characteristic vector for learning corresponding to the production condition vector for learning by the encoder;
by the learning unit, preparing a prototype of a first regressor in which the production condition vector for learning is used an input, the latent vector for learning is used as an output, and a weight of the production condition vector for learning is not determined; and
completing the first regressor by deriving a weight of the production condition vector for learning using the learning data.

6. A device for mutually inferring a composite characteristic and a composite production condition, the device comprising:
in case that, upon producing a composite using multiple materials, there is an encoder trained to calculate a latent vector from a characteristic vector indicating a target composite characteristic,
an inference unit:
when a production condition vector indicating a production condition for obtaining the composite characteristic is received, calculating, through a first regressor, a simulated latent vector simulating the latent vector from the input production condition vector, and
calculating, through a decoder, a simulated characteristic vector simulating the characteristic vector from the simulated latent vector and an experimental condition vector indicating an experimental condition for measuring the composite characteristic.

7. The device of claim 6, wherein the inference unit:
when a characteristic vector is received, calculates a latent vector from the characteristic vector through the encoder, and
calculates, through a second regressor, a simulated production condition vector simulating the production condition vector from the latent vector.

8. The device of claim 7, further comprising:
a learning unit:
receiving a characteristic vector for learning into the encoder such that the encoder calculates a latent vector for learning from the characteristic vector for learning,
receiving a latent vector for learning and an experimental condition vector for learning into the decoder such that the decoder calculates a simulated characteristic vector for learning from the latent vector for learning and the experimental condition vector for learning,
calculating a loss representing a difference between the simulated characteristic vector for learning and the characteristic vector for learning, and
performing optimization to update parameters of the encoder and the decoder to minimize the loss.

9. The device of claim 7, further comprising:
a learning unit:
preparing a plurality of learning data, each of which includes a latent vector for learning derived from a characteristic vector for learning by the encoder and a production condition vector for learning corresponding to the characteristic vector for learning,
preparing a prototype of a second regressor in which the latent vector for learning is used as an input, the production condition vector for learning is used as an output, and a weight for the latent vector for learning is not determined, and
completing the second regressor by deriving a weight for the latent vector for learning using the learning data.

10. The device of claim 7, further comprising:
a learning unit:
preparing a plurality of learning data, each of which includes a production condition vector for learning and a latent vector for learning derived from a characteristic vector for learning corresponding to the production condition vector for learning by the encoder,
preparing a prototype of a first regressor in which the production condition vector for learning is used an input, the latent vector for learning is used as an output, and a weight of the production condition vector for learning is not determined, and
completing the first regressor by deriving a weight of the production condition vector for learning using the learning data.
